(19) United States
(12) Patent Application Publication
(10) Pub. No.: US 2025/0082436 A1
(43) Pub. Date: Mar. 13, 2025

(54) SIMPLIFIED SYSTEM AND PROCEDURE FOR COMPUTER-GUIDED DENTAL IMPLANT SURGERY

(71) Applicant: BROK SPA, Concepción (CL)

(72) Inventor: Jorge JOFRE ARAYA, San Pedro de la Paz (CL)

(73) Assignee: BROK SPA, Concepción (CL)

(21) Appl. No.: 18/727,318

(22) PCT Filed: Jan. 10, 2023
(86) PCT No.: PCT/IB2023/050194

§ 371 Date: Jul. 8, 2024

(30) Foreign Application Priority Data
Jan. 11, 2022 (CL) 0072-2022

(51) Int. Cl. A61C 1/08

(52) U.S. Cl. CPC A61C 1/084

(57) ABSTRACT

We disclosed a simplified computer-guided drilling system and procedure for performing dental implant surgery. The system comprises: a drilling expansion means, which comprises a drilling body with a pointed end attached to a smooth-walled cylindrical body; and one or more expansion means of the perforation, comprising a guide body with a pointed end maintaining the drilling position, and a second bod with a cylindrical-conical shape whose diameter increases as moving away from the end, for allowing the insertion of an implant whose shape corresponds to the last expansion means but with a larger diameter; wherein the smooth-walled cylindrical body precisely fits an opening in a previously computer made guide element, wherein said opening defines a drilling position and a drilling direction.

The present invention relates to systems and equipment used for dental implant surgeries, and more specifically to a simplified system and procedure for computer-guided drilling, which allow inserting dental implants by bone expansion.

### BACKGROUND

Dental implant surgery has become a routine treatment in dentistry. However, the success of this treatment can only be ensured by proper implant placement that allows for an aesthetic result and long-term bone stability (Fuentealba and Jofre 2015; Shen et al. 2015; Hinckfuss et al. 2012). The computer-guided implant surgeries are the best and most advanced tool to achieve this, which are a reverse engineering flowchart, which begins on planning, on a three-dimensional radiographic image of the patient (Cone beam), first establishing the ideal position of the future teeth, for then virtually plan the ideal position of the implants that are anchored to the bone. Then, positioning guides are digitally made, which are manufactured by three-dimensional printing, and through the use of specially designed surgical instruments, implant surgeries can be performed according to virtually plan.

The use of these guides provides numerous advantages, among which, it stands out a better postoperative period due to the fact that surgeries are performed without flap (without lifting the gum), which reduces the intervention time, pain intensity, need of analgesics and recovery time (Sun et al. 2015; Turbush & Turkyilmaz 2012; Sammartino et al. 2004). Undoubtedly, this is an important benefit, since a high incidence of bone perforations is reported when trying to perform flapless surgeries with free-hand techniques, without the use of guides, while the use of guides in the indicated cases reduces the risk and improves procedural safety (Behneke et al. 2012). With this, it is emerging as an alternative for certain patients with general medical commitment who cannot opt for conventional surgery, or in cases of therapy with bisphosphonates, radiation or anticoagulants (Behneke et al. 2012; Van de Wiele et al. 2015; Hultin et al. 2012), as long as they meet the minimum criteria for bone and gum volume. Furthermore, this device allows increasing safety, by maintaining the planned implant position with a certain margin of error (Sun et al. 2015; Sarment et al. 2003).

The final result for the patient, especially aesthetics, is an aspect highly benefited by the use of 3D surgical guides, since the correct location of the implant in the three planes of space is the basis for the future rehabilitation success (Fuentealba and Jofre 2015, Shen et al. 2015; Hinckfuss et al. 2012).

The impact of guided surgery was such that 25% of dentists were expected to adopt this technology by 2012 (Millenium Research Group). However, even though it is still the fastest growing segment of implantology, and there are many guide systems on the market, currently no more than 5% of surgeries are performed with this technology. This is due to numerous causes, which are discussed below.

The used instrument sets for computer-guided surgeries have been extrapolated from other disciplines and are designed to drill materials of composition and nature very different from jawbone. They are instruments or excavation burs, which cannot be used in areas of atrophic or reabsorbed bones, which correspond to over than 50% of patients, and which must undergo previous reconstructive surgeries, which makes the treatments more extensive and traumatic. In addition, they present an intrinsic error, which corresponds to the difference between the internal diameter of the guide cylinder and the respective drilling bur, which results in the lateral deviation of the implant. This can represent 62.6% of the total error (M. Cassetta et al. 2013, Cassetta et al. 2014, Sun et al 2015), constituting an extremely significant factor, estimating that, by itself, it can cause angular deviations of up to 5.15° total. Tahmaseb et al. reported, based on their systematic review, deviations of up to 7.90° in cadaver studies, and up to 8.54° in clinical studies (1560 implants) (Tahmaseb et al. 2014).

While the less tolerance between the cylinder and the respective cutter, there should be greater precision, but instead there is a greater friction between the components, which reduces the tactile sensitivity of the operator. This characteristic is essential for executing different drilling protocols for bones of different densities, as it ensures implant stability when the bone is very soft and facilitates insertion when it is very dense.

Added to all of the above, there is the obstruction of the operative field visibility and the difficulty of the surgical bed irrigation at the time of drilling, which translates into the increase in temperature recorded by Misir et al., compared to the free hand classical technique of surgical bed preparation, confirming the hypothesis that the guide cylinders would prevent the irrigation arrival to the bone (Misir et al. 2009). This requires additional external irrigation with refrigerated serum, which makes the procedure more complex.

Additionally, current conventional protocol prepared 3D surgical guides have a fairly significant production cost in relation to the total cost of the implant (Chiarelli et al. 2012; Farley et al. 2013; Papaspyridakos et al. 2012; Meloni et al. 2013).

The currently used procedure is complex, it requires many stages and instruments, showing over than 36.4% complications (Tahmaseb et. Al 2014), thus it is not recommended to be carried out by beginners, but experienced surgeons and in cases providing a good anatomical safety margin. 3D guides have been shown to require experience from the surgeon and a learning curve that provides greater reliability (Van de Wiele et al. 2015). In complex cases, with poor bone availability for implant insertion and, therefore, a higher risk of error margin, novice surgeons are more likely to generate poor implant position, depth, or inclination (Shen et al. 2015). The most experienced surgeons are not encouraged to invest time and money in a technology designed only for low complexity cases, with adequate bone volumes, leaving no possibility of using this technology in patients with deficient bones, which are the most complex procedures, corresponding to over than 50% of the people requesting implant treatments.

There are companies, institutions and private clinics developing prototypes of anatomical models, which they call “surgical guides”. These offer digital manufacturing services with desktop 3D printers; however, they must use the instrument sets for guided surgery available in the market, thus they do not solve the basic problem found in the instruments, which due to the large number of components makes its application difficult, with a high failure rate. Its drills are designed for drilling and removing material, excavating, which renders necessary to use them only when the bone volume is large, to provide a safety margin for the preparation of the implant bed.

### STATE OF THE ART

Current guides use an instrument set containing drills and guide cylinders totaling more than 50 components on average (U.S. Pat. No. 8,777,612). Thus, during the surgical phase, interchangeable cylinders are used adapting to the different drill diameters, until the implant site preparation is completed (Sun et al. 2015; Cassetta et al. 2014).

The latest versions of these instruments have attempt to reduce the number of guide cylinders, leaving only one wider cylinder, and it is the cutters that adapt to this cylinder, increasing its diameter in its non-active part, thou this makes harder for visibility, irrigation, handling and the reduction in components is not significant.

The improvements in the surgical instruments used to drill the bone have been aimed at improving its cutting capacity (WO 2018 2026 05A1) or low speed bone drilling (WO 2017174648 A1; AU 2019200021 A1), thou this design is more user-friendly with the bone, it cannot be used in computer-guided surgeries, since a cylindrical profile is required to serve as a guide and rotation at high speed. Nor can it be used in areas of deficient or resorbed bone, which correspond to over than 50% of patients.

In conventional implant surgery, new concepts of bone preparation have appeared, called osteocondensation, which uses blunt burs turning in the reverse direction, so that there is not a cutting effect but a lateral compaction that expands the bone, which is elastic in nature (U.S. Pat. No. 9,737,312 B2). The design of these burs is similar to the conventional one and does not allow to be guided by computer.

### BRIEF DESCRIPTION OF THE INVENTION

To remedy the shortcomings of the prior art, a simplified computer-guided drilling system is provided allowing dental implant surgery to be performed. The system comprises:
an expansion drilling means, which comprises a drilling body with a pointed end attached to a smooth-walled cylindrical body; and
one or more expansion means of the perforation, comprising a guide body with its pointed end that maintains the drilling position, and a second body of cylindrical-conical shape whose diameter increases as it moves away from the end, allowing the insertion of an implant whose shape corresponds to the last expansion element but with a larger diameter;
wherein the smooth-walled cylindrical body precisely fits an opening in a previously computer made guide element, wherein said opening defines a drilling position and a drilling direction.

In this way, by means of the system configuration that is described, it is possible to avoid the deviation problems in the drilling that occur in the prior art, since the drilling means comprises a cylindrical body that precisely fits an opening in a previously computer manufactured guide element, thus allowing defining a drilling position and a drilling direction, while at the same time maintaining the position determined in the planning during the system operation.

Furthermore, due to the fact that the drilling means comprises a drilling body with a pointed end, rotating this piece facilitates its introduction into the cortex of atrophic bones, making a first expansion of these. This allows for the drilling and expansion of the bone simultaneously while maintaining a virtually determined position.

Preferably, the one or more expansion means of the perforation have incremental diameters and the guide body with a pointed end allows to maintain the position determined by the drilling means, avoiding the need for additional elements to ensure the position and direction during operation, and improving visibility and irrigation. Thus, the use of expansion means with incremental diameters makes it possible for maintaining the initial position and expand the bone until obtaining beds with a sufficient diameter for the subsequent insertion of an implant.

The invention further contemplates a drilling procedure to perform computer-guided dental implant surgery, comprising the steps of:
fabricating a guide element comprising an opening providing a drilling position and direction, wherein the opening is spatially oriented according to a planned direction in a computational radiographic image;
inserting through the opening an expansion drilling means, which comprises a drilling body with a pointed end attached to a smooth-walled cylindrical body that matches the opening size; and
withdrawing the guide element and sequentially introducing one or more expansion means of the perforation into the formed perforation, comprising a guide body at its end to maintain its position and direction and a frustoconical body allowing the expansion of the perforation.

In this way, in the described procedure, the guide element is removed after the application of the drilling means, subsequently, having the professional in charge a direct vision and irrigation, a first means of expansion of the perforation is introduced into the initial osteotomy, whose tip or end adapts to the initial preparation, maintaining its position, since it has a similar geometry to the first but with a larger diameter. The preparation continues with one or more expansion means having an equivalent geometry but with incremental diameters allowing the trajectory to be maintained, expanding the bone tissue to the diameter required for the insertion of the implant. This allows to maintain the determined direction virtually but with the benefits of an unguided free-hand surgery, such as the visualization of the surgical field, irrigation, management of the osteotomy according to bone density, control of the primary stability of the implant. In addition, the geometry of the drilling and expansion means, with sharp points and non-cutting lateral faces, allows the bone tissue walls to be preserved and expanded, extending its indication for areas of deficient or atrophic bone, which currently must previously undergo reconstructive surgeries.

In view of the above, the disclosed system and procedure allow it use in more complex cases, where there is limited bone and gum volume, which corresponds to over than 50% of the people consulting for implants and who with the technologies of the prior art is not possible to perform this type of procedure.

On the other hand, the disclosed proposal also considerably reduces the number of components, since it preferably requires the use of two expansion means giving a total of four elements in the system. This clearly contrasts with conventional prior art instruments for guided surgery, considerably lowering costs, which are much higher than the free-hand technique (Kühl et al. 2013).

Being much simpler, it would allow beginner dentists to have a direct view of the operative field, and to change the bone preparation sequence, according to its sensation of hardness, facilitating implant stability, without losing the benefit of a guided surgery and thus simplifying the dental implant insertion procedure.

### BRIEF DESCRIPTION OF THE FIGURES

FIGS. 1a and 1b show a schematic representation of a drilling means and its parts.

FIG. 2 shows a schematic representation of an expansion means and the detail of a cross section thereof.

FIG. 3 shows a representation of a sequence of steps for the application of the implant fixation procedure with computer-guided bone expansion, using the system of the present invention.

FIG. 4 shows a schematic representation of an implant and its parts.

FIG. 5 shows a schematic representation of an alternative configuration of an expansion means and a sectional view thereof.

FIGS. 6a and 6b show a representation of bone loss using a conventional prior art system and using the present invention.

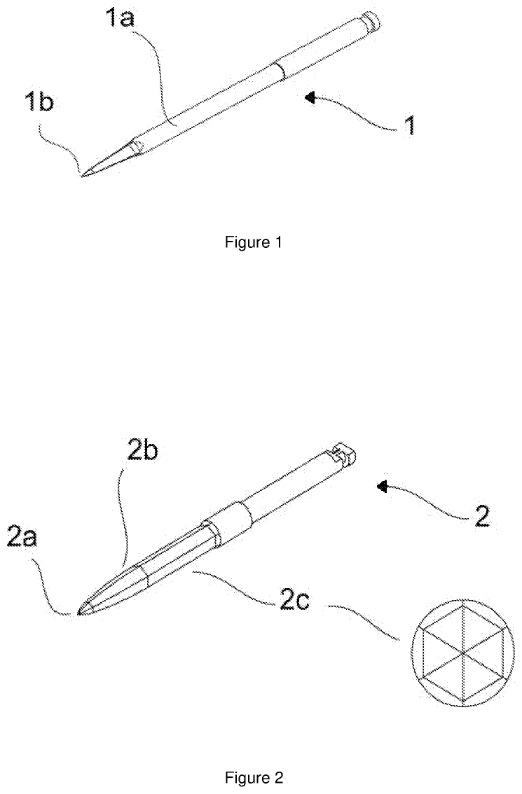

### DETAILED DESCRIPTION OF THE INVENTION

According to the configurations shown in the accompanying figures, the present invention consists of a simplified computer-guided drilling system for performing dental implant surgery, comprising:
an expansion drilling means (1), which comprises a drilling body with a pointed end (1b) attached to a smooth-walled cylindrical body (1a); and
one or more expansion means (2) of the perforation, comprising a guide body with its pointed end (2a) that maintains the drilling position, and a second body with a cylindrical-conical shape (2b) whose diameter increases as it moves further away from the end, allowing the insertion of an implant (4) whose shape corresponds to the last expansion element but with a larger diameter;
wherein the smooth-walled cylindrical body (1a) precisely fits an opening (3c) in a previously computer made guide element (3b), wherein said opening defines a drilling position and a drilling direction.

Preferably, the drilling means (1) and the one or more expansion means (2) of the perforation are inserted sequentially, and have a progressively larger diameter allowing the size of the perforation to be increased. Furthermore, the pointed end drilling body (1b) corresponds to the pointed end of the guide body (2a) of a first expansion means of the perforation, thus allowing the position determined by the drilling means to be maintained.

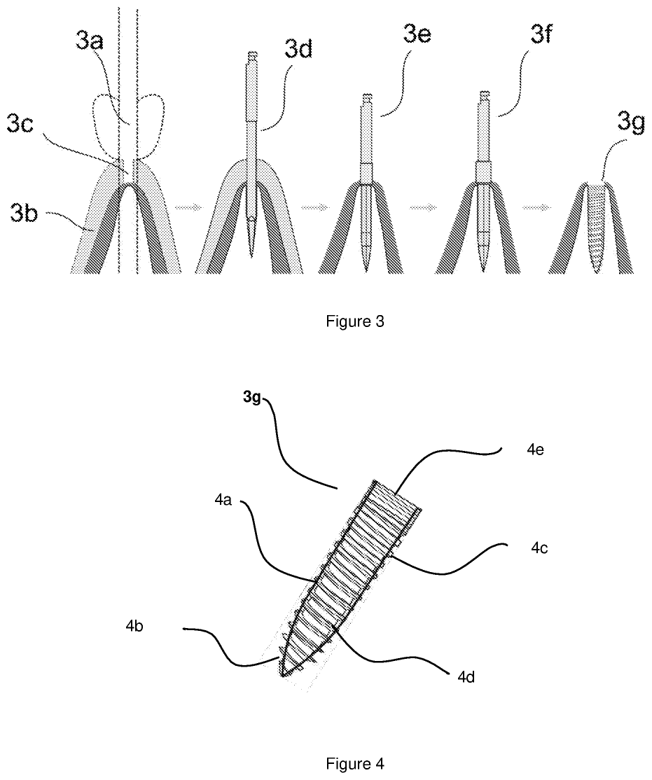

In this way, the expansion drilling means (1) is precisely adjusted to the opening (3c) which operates as a pre-fabricated computer guide for maintaining the position determined in the planning, as shown more clearly in the FIG. 3. Said drilling means (1) comprises at its end a second body in the shape of a pyramid with a sharp point (1b) that when rotating, preferably connected to a dental motor, facilitates its introduction into the cortex of atrophic bones, making a first expansion thereof. These instruments can be connected to a dental motor rotating at revolutions ranging from 400 to 2000 RPM, allowing the drilling and expansion of the bone simultaneously and maintaining a predetermined position virtually.

In preferred configurations of the invention, the smooth-walled cylindrical body (1a) of the drilling means (1) has a diameter that is in a range between 1 to 4 millimeters, and more preferably 2 mm, and has a length that is in a range between 5 to 20 millimeters, and more preferably the length is 10 mm.

The drilling body (1b) of the drilling means comprises a sharp pointed pyramid shape. Preferably, the pointed pyramid of the drilling body has between 3 to 8 lateral faces, and more preferably it has 4 lateral faces.

According to FIG. 2, the drilling system comprises a sequence of expansion means of incremental diameters, constituted by a guide body with a pointed end (2a) that allows maintaining the position determined by the drilling means (1). These bodies with pointed ends (2a) are connected to a second body with a cylindrical-conical shape (2b) that progressively increases its diameter towards the rear of the device, thus allowing the perforation to expand. In addition, the diameter of said means increases progressively between the different expansion means (2), in such a way that the body base of each one of them corresponds to the guide body of the end or tip of the next one, always maintaining the drilling position.

In preferred configurations of the invention, the second body (2b) of the expansion means (2) comprises a plurality of lateral faces, which in a cross-sectional view have a regular polygon shape (2c). The regular polygon shape can correspond to different shapes, such as quadrangular, hexagonal, octagonal, or others. Preferably, the regular polygon has between 3 to 8 faces and more, preferably it has 6 faces.

Preferably, the expansion means (2) are at least three, wherein a first means in its widest part has a diameter between 2.4 to 2.8 mm, and more preferably 2.6. The second expansion means has at its widest part a diameter between 2.9 to 3.5 mm, and more preferably 3.2, and the third expansion means has a diameter between 3.6 to 4.1 mm at its widest part of, and more preferably 3.8.

According to FIG. 3, an exemplary surgical procedure begins with a planning on a three-dimensional radiographic image of the patient (Cone beam). This planning allows by means of reverse engineering to visualize the final restoration and to project the ideal position that the implant should have (3a), and print the guide element (3b) that contains the opening (3c) meant to maintain the direction of the drilling means (3d) during the drilling process, according to the previously planned direction.

When the drilling process has finished, the drilling means (3d) is removed and, with direct vision and irrigation, the first expansion means (3e) is introduced into the initial osteotomy, whose tip or end thereof adapts to the initial drilling, maintaining its position. This is because the first expansion means (3e) has a similar geometry to the drilling means (3d), but with a larger diameter. In this way, only the first drilling means (3d) requires a guide element (3b) and the following expansion means (3e, 3f) maintain the position, without requiring said guide element (3b).

FIG. 4 shows a detailed view of the implant (3g) shown in FIG. 3. In this configuration, the implant (3g) comprises a conical cylinder-shaped body (4a), with a sharp point (4b) corresponding to the shape of the expansion elements (3e, 3f).

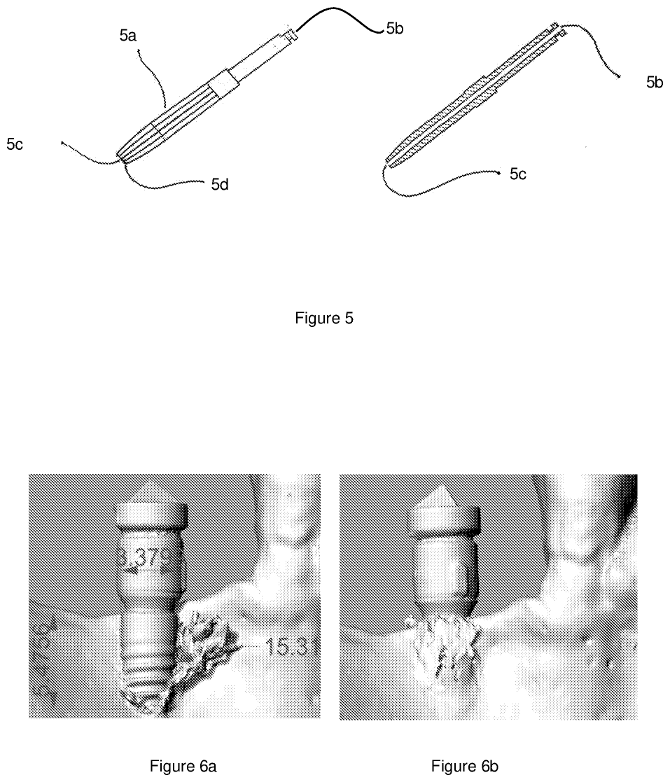

Preferably, the implant (3g) has a double spiral thread shape, which allows the bone expansion to be terminated and gives it stability. In this configuration, the thread preferably reduces its width and increases its depth towards the pointed end, as represented by numerals 4c and 4d. Furthermore, at its upper end thereof, it comprises a prosthetic connection (4e) for coupling with a rehabilitation pillar (not shown in the figures). FIG. 5 shows a front view and a sectional view of an alternative configuration of an expansion means (5a), wherein said expansion means (5a) comprises an axial perforation in the central area thereof, allowing the passage of a coolant flow. Said perforation passes through the expansion means through its two ends (5b, 5c), and allows irrigation in order to separate the membrane from the maxillary sinus and prevent its rupture. At the lower end thereof, this perforation ends in a serrated area adopting a crown shape with rounded corners (5d).

FIGS. 6a and 6b allow contrasting bone loss when using a conventional prior art system and the system of the present invention. More particularly, FIG. 6a shows the effects on bone loss using a conventional prior art system, while FIG. 6b shows the effects of using the system of the present invention.

The invention contemplates a drilling procedure to perform a computer-guided dental implant surgery, comprising the steps of:
fabricating a guide element (3b) comprising an opening (3c) providing a drilling position and direction, wherein the opening is spatially oriented according to a planned direction in a computational radiographic image;
inserting through the opening (3c) a means for generating a perforation, which comprises a drilling body with a pointed end (1b) attached to a smooth-walled cylindrical body (1a) that adjusts to the size of the opening; and
removing the guide element and introducing sequentially into the formed perforation one or more expansion means of the perforation, comprising a guide body at its end (2a) thereof for maintaining its position and direction and a frustoconical body (2b) allowing expanding the perforation.

Preferably, the procedure comprises the additional step of sequentially introducing the one or more expansion means of the perforation, which have a progressively larger diameter, until reaching the size required for inserting an implant.

### APPLICATION EXAMPLES

The effectiveness of this new product was compared with that of a conventional guided surgery set, on an artificial bone model, taken from a real patient scan, which was replicated 20 times. The implant position was planned virtually and guides were constructed by three-dimensional impression. Using one of the most recognized guided surgery systems available on the market, 10 implants were inserted in 10 models. In the remaining 10 models, 10 implants were inserted using the system of the present invention. To determine the precision of both systems, the models with the implants inside were digitized and compared with virtual planning. The results showed that there were no significant differences between the mean angular deviation between the two comparison groups (T-Test, p=0.28).

Additionally, bone loss around the implants was measured with both systems. As shown in FIG. 6, conventional drills removed twice as much bone (FIG. 6a) compared to the system of the present invention (FIG. 6b), leaving an area of 7.67±4.74 mm² exposed, versus 3.43±4.32 mm² of the new system.

The conventional guide system left an exposed surface of the implants, which on average was statistically significant when compared with the system of the present invention (T-Test, p=0.015).

The present invention has been clinically evaluated by inserting, based on virtual planning, a total of 171 implants in 63 patients with severe atrophies, which under regular conditions would require prior reconstruction with grafts. In 95.4% of the cases reconstructions with bone grafts were avoided, with a simple, safe and minimally invasive surgery, which is evidenced by the great acceptance shown by the operators and patients after the intervention, as shown in Table 1.

In this sample, 3 complications (1.7%) associated with mucosal lesions caused by the prostheses were recorded. No surgical complications.

TABLE 1

| No. of | | | | | | |
|---|---|---|---|---|---|---|
| Implants | Cases | Total | Flap | Position | Grafts | Complications |
| 1 | 27 | 27 | Correcta | 0 | 0 | 0 |
| 2 | 10 | 20 | Correcta | 0 | 0 | 0 |
| 3 | 5 | 15 | Correcta | 0 | 0 | 0 |
| 4 | 7 | 28 | Correcta | 2 | 2 | 0 |
| 5 | 5 | 25 | Correcta | 2 | 2 | 0 |
| 6 | 8 | 48 | Correcta | 4 | 4 | 3 |
| 8 | 1 | 8 | Correcta | 0 | 0 | 0 |

Total implants: 171

Finally, it should be taken into consideration that the invention has been described mainly with reference to some preferred embodiments, exemplified in the accompanying figures. However, one skilled in the art will readily recognize that other embodiments or modifications are equally possible within the spirit of the invention. For example, the chosen materials, the dimensions, the shapes and the location of the different elements may vary according to the specific requirements of each implementation. Accordingly, the foregoing detailed description is to be understood broadly, the spirit and scope of the invention being limited only by the appended claims.

1. A simplified computer-guided drilling system for performing dental implant surgery, the system used with a computer made guide element (3b) having an opening (3c) therein, wherein said opening defines a drilling position and a drilling direction, the system comprising:
a guided perforation drilling means (1), which comprises a drilling body with a pointed end (1b) attached to a smooth-walled cylindrical body (1a); and
one or more expansion means (2) each comprising a guide body with a pointed end (2a) that maintains the drilling position, and a second guide body with a cylindrical-conical shape (2b) and having a diameter that increases as it moves away from the pointed end, to allow the insertion of an implant (3g) whose shape corresponds to a last expansion means but with a larger diameter than the last expansion means;
wherein the smooth-walled cylindrical body (1a) precisely fits the opening (3c) in the guide element.

2. The drilling system according to claim 1, wherein the perforation drilling means has a maximum diameter and the expansion means has a larger maximum diameter than the perforation drilling means, wherein during dental implant surgery the drilling means and expansion means can be inserted sequentially.

3. The drilling system according to claim 2, wherein the pointed end of the perforation drilling body (1b) corresponds to the pointed end of the guide body (2a) of a first-expansion means and during use is operative for maintaining the drilling position.

4. The drilling system according to claim 2, wherein during dental implant surgery the pointed end of the guide body (2a) is operative to maintain the drilling position and the cylindrical-conical body (2b) is operative to expand the perforation, allowing the perforation to correspond to the shape of the pointed end of the guide body of a second expansion means, for always maintaining the drilling position.

5. The drilling system according to claim 2, wherein during dental implant surgery the drilling means (1) is used with the guide element and the at least one expansion means (2) maintain the drilling position without requiring the guide element.

6. The drilling system according to claim 1, wherein the perforation drilling means and the expansion means are connected to a surgical motor configured to rotate between 400 and 2000 RPM, allowing an easy perforation of the cortex of the bone, through the opening of the guide element and to the expansion without guide element.

7. The drilling system according to claim 1, the one or more perforation expansion means comprising a plurality of perforation expansion means, each respective perforation expansion means having a respective maximum diameter, wherein the respective maximum diameters of the plurality of perforation expansion means sequentially progressively increase.

8. The drilling system according to claim 1, wherein the second body (2b) of the expansion means comprises a plurality of lateral faces, which in a cross-sectional view have a regular polygon shape (2c).

9. The drilling system according to claim 8, wherein the regular polygon shape corresponds to a quadrangular, hexagonal or octagonal shape.

10. The drilling system according to claim 8, wherein the regular polygon has between 4 to 8 faces.

11. The drilling system according to claim 10, wherein the regular polygon has 6 faces.

12. The drilling system according to claim 1, wherein the smooth-walled cylindrical body (1a) has a diameter that is in a range between 1 to 4 millimeters and a length that is in a range between 5 to 20 millimeters.

13. The drilling system according to claim 12, wherein the smooth-walled cylindrical body (1a) has a diameter of 2 millimeters and a length of 10 millimeters.

14. The drilling system according to claim 1, wherein the drilling body (1b) of the drilling means comprises a sharp pointed pyramid shape.

15. The drilling system according to claim 14, wherein the sharp pointed pyramid shape comprises between 3 to 8 lateral faces.

16. The drilling system according to claim 15, wherein the drilling body comprises a pyramid shape having 6 lateral faces.

17. The drilling system according to claim 1, comprising at least three expansion means, wherein a first expansion means in its widest part has a diameter between 2.4 to 2.8 mm, a second expansion means in its widest part it has a diameter between 2.9 to 3.5 mm, and a third expansion means in its widest part has a diameter between 3.6 to 4.1 mm.

18. A drilling system according to claim 17, wherein the first expansion means at its widest part has a diameter of 2.6 mm, the second expansion means at its widest part has a diameter of 3.2 mm, the third expansion means at its widest part has a diameter of 3.8 mm.

19. The drilling system according to claim 1, wherein the one or more-expansion means each comprise a perforation in a central area thereof configured to allow the passage of a coolant liquid flow.

20. The drilling system according to claim 19, wherein the expansion means has at the pointed end thereof, a crown shape with rounded corners.

21. The drilling system according to claim 1, further comprising an implant to be inserted, the implant comprises body with a conical cylinder shape, with a sharp point at a tip of the implant, and that corresponds to the shape of the expansion means.

22. The drilling system according to claim 1, wherein the implant comprises a double spiral thread, wherein the double spiral thread allows completing bone expansion and provides stability.

23. The drilling system according to claim 22, wherein a width of the thread thins and a depth of the thread increases from a back of the implant towards the tip of the implant.

24. A drilling procedure to perform a computer-guided dental implant surgery, the method comprising the steps of:
fabricating a guide element (3b) comprising an opening (3c) providing a drilling position and direction, wherein the opening is spatially oriented according to a planned direction in a computational radiographic image;
inserting through the opening (3c) a perforation drilling means, which comprises a drilling body with a pointed end (1b) attached to a smooth-walled cylindrical body (1a) that adjusts to the size of the opening; and
removing the guide element and introducing sequentially into the formed perforation one or more expansion means, each respective expansion means comprising a guide body at an end (2a) thereof for maintaining its position and direction and a frustoconical body (2b) that allows expansion drilling.

25. The drilling procedure according to claim 24, wherein the one or more expansion means of the perforation have a progressively larger maximum diameters and are introduced sequentially in an order of increasing diameter until reaching a required size for the insertion of an implant.

26. The drilling procedure according to claim 24, wherein the cylindrical shape of the guide body (1a) of the perforation drilling means corresponds to the opening (3c) of the guide element (3b).

27. The drilling procedure according to claim 24, wherein the base of the second body (2b) of the first expansion means corresponds to the pointed shape of the guide body (2a) of a second expansion means of the subsequent drilling.

28. The drilling procedure according to claim 24, wherein one guided perforation and at least three expansion means are introduced in sequence, wherein a first perforation means has a respective diameter and each subsequent expansion means has respective a diameter greater than that of its predecessor.
